(19) United States
(12) Patent Application Publication
(10) Pub. No.: US 2016/0089746 A1
(43) Pub. Date: Mar. 31, 2016

(54) SPOT WELDING GUN FOR QUENCHING WELDING ZONE AND METHOD OF OPERATION THEREOF

(71) Applicant: HYUNDAI MOTOR COMPANY, Seoul (KR)

(72) Inventor: Do Woon CHO, Gunpo-si (KR)

(21) Appl. No.: 14/559,606

(22) Filed: Dec. 3, 2014

(30) Foreign Application Priority Data
Sep. 30, 2014 (KR) 10-2014-0131649

(51) Int. Cl. B23K 11/30; B23K 11/25; B23K 11/24; B23K 11/11; B23K 11/31

(52) U.S. Cl. CPC B23K 11/3018; B23K 11/115; B23K 11/3009; B23K 11/314; B23K 11/241; B23K 11/255; B23K 11/252

(57) ABSTRACT

A spot welding gun for quenching a welding zone includes a welding tip configured to contact a metal plate material. A first electrode base is configured to have the first welding tip fixed thereto and apply a current to the first welding tip. A plurality of first cooling nozzles provided in the first electrode base and configured to spray a cooling medium around a contacting part of the welding tip. The contacting part contacts the metal plate material. A method of operation of a spot welding gun for quenching a welding zone is also disclosed.

### CROSS-REFERENCE TO RELATED APPLICATION

This application is based on and claims the benefit of priority to Korean Patent Application No. 10-2014-0131649, filed on Sep. 30, 2014 in the Korean Intellectual Property Office, the disclosure of which is incorporated herein in its entirety by reference.

### TECHNICAL FIELD

The present disclosure relates to a spot welding gun for quenching a welding zone and an operation method thereof, and more particularly, to a spot welding gun for quenching a welding zone which sprays a cooling medium around a bonding part from the welding gun and an operation method thereof.

### BACKGROUND

A global trend is that vehicle manufactures increase a use of high-tension steel in order to lighten a vehicle body and improve collision performance.

In order to join high-tension steel plates in a process of manufacturing the vehicle body, a resistance spot welding (hereinafter, referred to as spot welding) is used. However, strength of the high-tension steel plate around a welding zone is deteriorated due to welding heat which is generated upon the spot welding, and as a result, durability of the welding zone becomes vulnerable. In addition, as the durability of the welding zone becomes vulnerable, when evaluating durability of the product of the spot welding of the high-tension steel plate, strength of the welding portion is lower than the strength of the high-tension steel plate, and consequently, the welding zone is easily damaged.

### SUMMARY

The present disclosure has been made to solve the above-mentioned problems occurring in the prior art while advantages achieved by the prior art are maintained intact.

An aspect of the present inventive concept provides a spot welding gun for quenching a welding zone and an operation method thereof.

According to an exemplary embodiment of the present inventive concept, a spot welding gun for quenching a welding zone includes: a first welding tip configured to contact a stacked metal plate material; a first electrode base configured to have the first welding tip fixed thereto and apply a current to the first welding tip; and a plurality of first cooling nozzles provided in the electrode base and configured to spray a cooling medium around a contacting part of the welding tip. The contacting part is in contact with the metal plate material.

According to another exemplary embodiment of the present inventive concept, an operation method of a spot welding gun for quenching a welding zone includes: applying power to a welding tip which is in contact with a metal plate material and spraying a cooling medium from a cooling nozzle provided in an electrode base having the welding tip fixed thereto toward the metal plate material.

### BRIEF DESCRIPTION OF THE DRAWINGS

The above and other objects, features and advantages of the present inventive concept will be more apparent from the following detailed description taken in conjunction with the accompanying drawings.

FIG. 1 is a perspective view of a spot welding gun for quenching a welding zone according to an exemplary embodiment of the present inventive concept.

FIG. 2A is a front view of a main portion of the spot welding gun for quenching the welding zone of FIG. 1. FIG. 2B is a bottom view of a top part of the main portion shown in FIG. 2A. FIG. 2C is a perspective view of a nozzle sprayer according to an exemplary embodiment of the present inventive concept.

FIG. 3 is a flow chart of a method of operation of a spot welding gun for quenching a welding zone according to an exemplary embodiment of the present inventive concept.

### DETAILED DESCRIPTION

Exemplary embodiments of the present inventive concept will be described in detail with reference to the accompanying drawings.

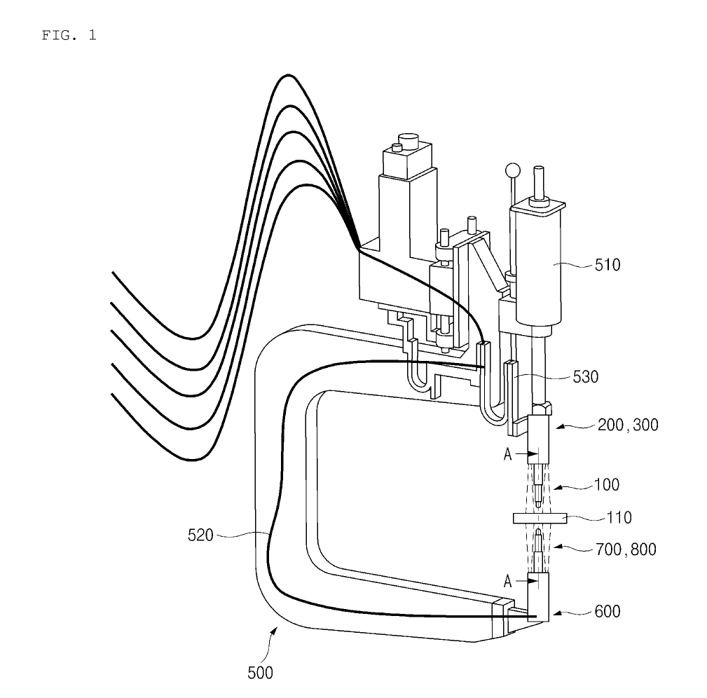

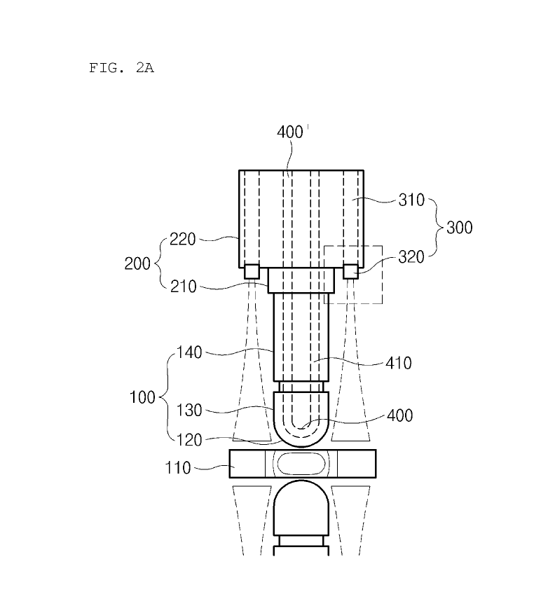

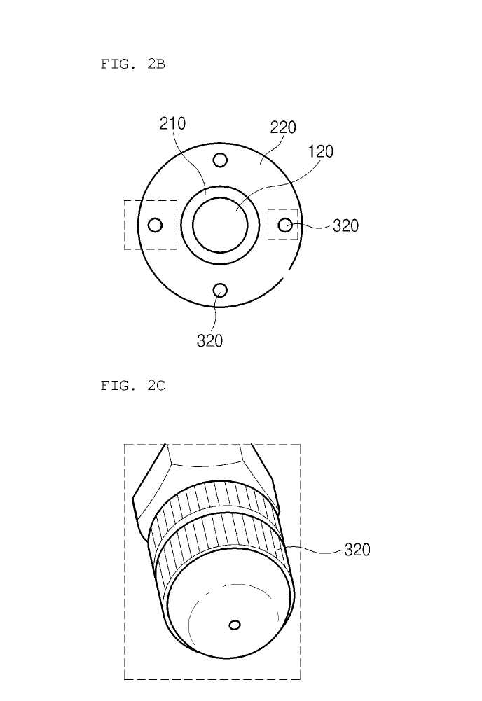

As shown in FIGS. 1-2C, a spot welding gun for quenching a welding zone according to an exemplary embodiment of the present inventive concept includes a first welding tip 100 which is in contact with a stacked metal plate material 110, a first electrode base 200 having the first welding tip 100 fixed thereto and applying a current to the first welding tip 100, and a plurality of first cooling nozzles 300 provided in the first electrode base 200 so as to spray a cooling medium around a contacting part 120 the first welding tip 100. The contacting part 120 contacts the metal plate material 110.

In this case, as the cooling medium, water, air, oil, CO₂, and the like may be used. In addition, the plurality of first cooling nozzles 300 is provided in the welding gun so as to be mounted around the first welding tip 100. An amount and a spray direction of cooling medium which is sprayed through the first cooling nozzle 300 are free within a range capable of satisfying a necessary cooling amount of metal plate material 110. According to the exemplary embodiment of the present inventive concept, the first electrode base 200 includes a fixing part 210 to which the first welding tip 100 is fixed, and a frame 220 formed to have a width wider than that of the fixing part 210. The first cooling nozzles 300 may be disposed around the fixing part in at least one of a vertical and horizontal direction relative to a center shaft and may extend in a longitudinal direction of the fixing part 210.

In certain embodiments, each of the first cooling nozzles 300 may include a cooling medium pipe 310 formed in the frame 220 and a nozzle sprayer 320 connected to the cooling medium pipe 310 and disposed around the fixing part 210. The first welding tip 100 and the first electrode base 200 may have at least one of a plurality of cooling passages 400 and 400′ formed therein, wherein a cooling water is circulated in the cooling passages 400 and 400′.

The first welding tip 100 includes a connecting part 140 connecting the first welding tip 100 and the first electrode base 200 to each other. The connecting part 140 is a conductor conducting electricity and has a connecting passage 410 formed therein, wherein the connecting passage 410 connects the cooling passages 400 and 400′ which are formed in the first welding tip 100 and the first electrode base 200. The first welding tip 100 may include a body part 130 having a cylindrical shape which is fastened to the first electrode base 200, and the contacting part 120 extended from the body part 130 in a hemispherical shape and is in contact with the metal plate material 110.

According to an exemplary embodiment of the present inventive concept, the spot welding gun for quenching the welding zone may further include a gun body 500 having the first electrode base 200 fixed thereto, a second electrode base 600 provided in the gun body 500 so as to be symmetrical with the first electrode base 200 with respect to the metal plate material 110, a second welding tip 700 fixed to the second electrode base 600 and which is symmetrical with the first welding tip 100 with respect to the metal plate material 110, and at least one second cooling nozzle 800 formed in the second electrode base 600.

in certain embodiments, the gun body 500 may include an actuator 510 configured to move the second electrode base 600 toward the metal plate material 110 and a supply pipe 520 configured to supply the current, the cooling water, and the cooling medium to the first electrode base 200 and the second electrode base 600.

According to an exemplary embodiment of the present inventive concept, the actuator 510 may be a pneumatic cylinder attached to one end of the second electrode base 600 so as to extend along a length direction of the second electrode base 600. The gun body 500 is provided with a guide 530 having the second welding tip 700 fastened thereto and configured to induce a movement of the second welding tip 700 according to an operation of the actuator 510.

The spot welding gun for quenching the welding zone according to the present inventive concept having the above-mentioned configuration may quench the welding zone by the cooling medium which is sprayed from the first cooling nozzle 300 simultaneously with the welding. Consequently, a problem that mechanical strength around the welding zone by heat which is generated upon the spot welding is deteriorated may be solved.

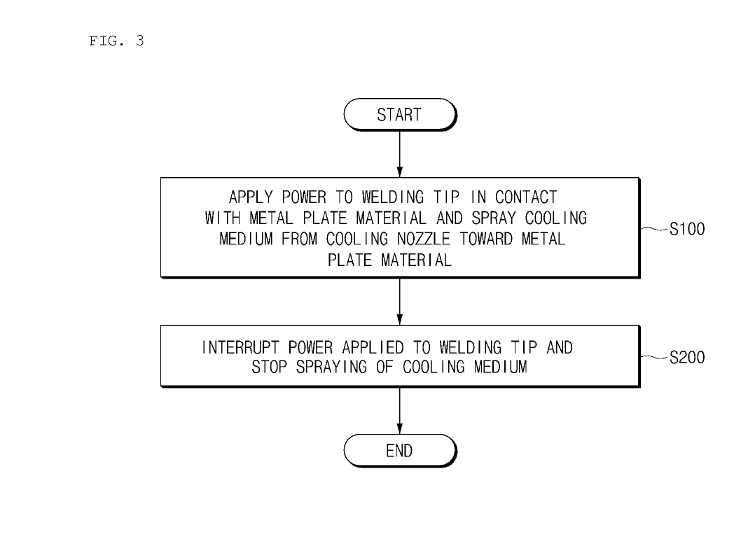

As shown in FIG. 3, a method of operation of a spot welding gun for quenching a welding zone according to an exemplary embodiment of the present inventive concept includes applying power to a first welding tip 100 which is in contact with a metal plate material 110 and spraying a cooling medium from a first cooling nozzle 300 provided in the first electrode base 200, having the first welding tip 100 fixed thereto, toward the metal plate material 110 (S100).

In certain embodiments, the first welding tip 100 may be moved to a welding position before being in contact with the metal plate material 110. In addition, in certain embodiments, the first welding tip 100 may be in contact with the metal plate material 110 so as to press the metal plate material 110. In this case, if pressure pressing the metal plate material 110 is not measured by the first welding tip 100, the operation of the welding gun may be stopped.

According to an exemplary embodiment of the present inventive concept, the method of operation of the spot welding gun for quenching the welding zone may further include interrupting the power which is applied to the first welding tip 100 and stopping the spraying of the cooling medium from the first cooling nozzle 300 (S200). In certain embodiments, if the power is not applied to the first welding tip 100 or the cooling medium is not sprayed from the first cooling nozzle 300, the operation of the welding gun may be stopped.

In certain embodiments, after the spraying of the cooling medium from the first cooling nozzle 300 is stopped, the first welding tip 100 may be separated from the metal plate material 110 and may be moved to another welding zone.

In certain embodiments, if the power which is applied to the first welding tip 100 is not interrupted or the spraying of the cooling medium from the first cooling nozzle 300 is not stopped, the operation of the welding gun may be stopped. In addition, if the first welding tip 100 is not separated from the metal plate material 110, or is not moved to another welding zone, the operation of the welding gun may be stopped.

In the method of operation of the spot welding gun for quenching the welding zone according to an embodiment of the present inventive concept, since the operation of the welding gun is stopped in the case in which malfunction occurs during the operation of the welding gun, accidents which may occur due to the malfunction of the welding gun may be prevented.

As described above, in the spot welding gun for quenching the welding zone and the operation method thereof according to the exemplary embodiments of the present inventive concept, it is possible to prevent the durability of the welding zone from being vulnerable by cooling the high-tension steel plate around the welding zone by the cooling medium which is sprayed from a cooling nozzle upon the spot welding.

As described above, although the present inventive concept has been described with reference to exemplary embodiments and the accompanying drawings, it would be appreciated by those skilled in the art that the present inventive concept is not limited thereto but various modifications and alterations might be made without departing from the scope defined in the following claims.

1. A spot welding gun for quenching a welding zone, the spot welding gun comprising:
a first welding tip configured to contact a metal plate material;
a first electrode base configured to have the first welding tip fixed thereto and apply a current to the first welding tip; and
a plurality of first cooling nozzles provided in the first electrode base and configured to spray a cooling medium around a contacting part of the first welding tip.

2. The spot welding gun according to claim 1, wherein the first electrode base includes:
a fixing part to which the first welding tip is fixed, and
a frame having a width wider than that of the fixing part.

3. The spot welding gun according to claim 2, wherein each of the plurality of first cooling nozzles includes:
a cooling medium pipe formed in the frame; and
a nozzle sprayer connected to the cooling medium pipe and disposed around the fixing part.

4. The spot welding gun according to claim 2, wherein the first cooling nozzles are disposed around the fixing part in at least one of a vertical direction and a horizontal direction relative to a center shaft and may extend in a longitudinal direction of the fixing part.

5. The spot welding gun according to claim 1, wherein the first welding tip includes:
a body part having a substantially cylindrical shape which is fastened to the first electrode base, wherein the contacting part extends from the body part in a substantially hemispherical shape and is in contact with the metal plate material.

6. The spot welding gun according to claim 1, further comprising:
a gun body having the first electrode base fixed thereto;
a second electrode base provided in the gun body so as to be symmetrical with the first electrode base with respect to the metal plate material;
a second welding tip fixed to the second electrode base and be symmetrical with the first welding tip with respect to the metal plate material; and
at least one second cooling nozzle formed in the second electrode base.

7. The spot welding gun according to claim 6, wherein the gun body includes:
an actuator configured to move the second electrode base toward the metal plate material; and
a supply pipe configured to supply the current, cooling water, and the cooling medium to the first electrode base and the second electrode base.

8. The spot welding gun according to claim 7, wherein the gun body is provided with a guide having the second welding tip fastened thereto, the guide configured to induce a movement of the second welding tip according to an operation of the actuator.

9. The spot welding gun according to claim 3, wherein the cooling medium is at least one of water, air, oil, and CO₂.

10. A method of operation of a spot welding gun for quenching a welding zone, the method comprising:
applying power to a welding tip which is in contact with a metal plate material and
spraying a cooling medium from a cooling nozzle provided in an electrode base toward the metal plate material, the electrode base having the welding tip fixed thereto.

11. The method of claim 10, further comprising stopping the operation of the spot welding gun if the power is not applied to the welding tip or the cooling medium is not sprayed from the cooling nozzle.

12. The method according to claim 10, further comprising, before the step of applying power, and before the welding tip is in contact with the metal plate material, moving the welding tip to a welding position.

13. The operation method according to claim 10, wherein the welding tip is configured to press the metal plate material while in contact with the metal plate material.

14. The operation method according to claim 13, further comprising stopping the operation of the spot welding gun if pressure pressing the metal plate material is not measured by the welding tip.

15. The operation method according to claim 10, further comprising
interrupting the power which is applied to the welding tip and
stopping the spraying of the cooling medium from the cooling nozzle.

16. The operation method according to claim 15, further comprising stopping the operation of the spot welding gun if the power which is applied to the welding tip is not interrupted or the spraying of the cooling medium from the cooling nozzle is not stopped.

17. The operation method according to claim 15, further comprising, after the spraying of the cooling medium from the cooling nozzle is stopped,
separating the welding tip from the metal plate material and
moving the welding tip to another welding zone.

18. The operation method according to claim 17, further comprising stopping the operation of the spot welding gun if the welding tip is not separated from the metal plate material or moved to another welding zone.
